(19) United States
(12) Patent Application Publication
(10) Pub. No.: US 2006/0156977 A1
(43) Pub. Date: Jul. 20, 2006

(54) Blade coating apparatus and disk coating apparatus using the same

(75) Inventor: Shinsuke Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/332,553

(22) Filed: Jan. 17, 2006

(30) Foreign Application Priority Data
Jan. 18, 2005 (JP) P.2005-010569

(51) Int. Cl. B05C 11/11

(52) U.S. Cl. 118/504

(57) ABSTRACT

A blade coating apparatus comprising: the mask defined herein; and the blade defined herein; wherein a section of the blade perpendicular to a longitudinal direction of the blade is shaped as: a blade-movement-direction length of a pressure surface located on a lower side of the blade and facing a surface to be coated is 10 times to 20 times as large as a thickness of the coating liquid layer at the time of application; an angle α between the pressure surface and a front side surface of the blade located in front in the blade movement direction is in a range of 110°≦α≦150°; and an angle β between the pressure surface and a rear side surface of the blade located at the rear in the blade movement direction is in a range of 60°≦β<100°.

### FIELD OF THE INVENTION

The present invention relates to a blade coating apparatus for coating a flat substrate with a coating liquid by use of a blade, and a disk coating apparatus using the blade coating apparatus.

### BACKGROUND OF THE INVENTION

Various proposals have been heretofore made for stably applying a liquid coating material onto a to-be-coated surface of a to-be-coated member. For example, a coating apparatus disclosed in JP-A-63-224761 includes side frames sliding on a to-be-coated member, and two blades provided to extend between the side frames so as to form a pocket for storing a coating liquid. The coating apparatus drains and applies the coating liquid from the pocket onto the to-be-coated member through a gap which is located in a lower end of one of the blades on the downstream in a movement direction. The coating apparatus has a lubrication layer forming means for forming a lubrication layer on an upper surface of the to-be-coated member on which the side frames slide. With this configuration, the surface smoothness of lower surfaces of the side frames is improved so that continuous banding in the extension direction of the blades can be prevented from occurring in the to-be-coated surface.

A substrate coating apparatus disclosed in JP-A-9-10646 includes a micro rod bar having its lower portion soaked in a coating liquid tank, and a nip roller disposed above the micro rod bar and oppositely thereto. A substrate is fed while being nipped between the micro rod bar and the nip roller. Thus, a lower surface of the substrate is coated with a coating liquid. In the substrate coating apparatus, a thrust member is provided on a substrate entry side of the micro rod bar. The thrust member serves to support a front edge of the substrate from below so as to restrict bending of the front edge of the substrate. With this configuration, coating near the center of the front edge of the substrate can be prevented from being thicker than that on either side thereof. Thus, coating with a uniform thickness can be attained. Moreover, the vicinity of the center of a rear edge of the substrate can be prevented from abutting against an exit-side gate of the coating liquid tank. Thus, coating with a uniform thickness can be attained.

Further, a roll coater disclosed in JP-A-10-128221 includes a conveyance stage for conveying a sheet to be coated and a coating roll. The conveyance stage is moved to pass under the coating roll so that a solution is applied onto a surface of the sheet. In the conveyance stage, a retention plate for retaining the sheet is disposed on an upper surface of a base with a gap therebetween, while elastic members are disposed in a surface-direction intermediate portion of the gap axi-symmetrically with respect to a line segment passing through the center of the sheet in the movement direction of the conveyance stage. In addition, a circumferential edge portion of the retention plate is restricted by gap restricting means so that the gap can be adjusted. With this configuration, when the retention plate passes through the coating roll while pressing the coating roll, the retention plate tilts within the range of the gap so as to control the reaction force (elastic force) of the elastic members. Thus, the shock which may occur due to the contact entry of the retention plate can be relaxed. In this manner, unevenness in coating can be prevented from being caused by the shock vibration.

### SUMMARY OF THE INVENTION

The coating apparatus disclosed in JP-A-63-224761 can be indeed configured in a simple structure. However, an applicator partially supported on the to-be-coated member performs application while keeping a relative distance between the downstream-side blade and the to-be-coated member. As a result, there is a defect that the to-be-coated member is limited to a belt-like member such that uncoated portions may be generated on the opposite end sides of the blades.

The substrate coating apparatus disclosed in JP-A-9-10646 can perform coating in the full width because the nipped substrate is coated by the micro rod bar from below. However, the to-be-coated member is limited to a belt-like member or a rectangular member. When the liquid film becomes thick, there arises a problem that stripes may occur in the coated surface due to disorder of beads on the downstream side of the micro rod bar.

The roll coater disclosed in JP-A-10-128221 can coat each to-be-coated member which will be shaped like a disk, and also can coat the whole surface of the to-be-coated member. However, each to-be-coated member must be supported by the elastic members. Accordingly, the equipment becomes so massive. In addition, when the liquid film becomes thick, there also arises a problem that stripes may occur in the same manner as in the aforementioned substrate coating apparatus.

In brief, the background art has the following defects. That is, the apparatus becomes massive. Particularly when the coating thickness increases, the quantity of the coating liquid pushed into the gap between each blade and the to-be-coated surface increases. Due to distortion of the blade brought about thus, there may appear stripes approximately parallel in the coating direction, or disorder of the liquid interface immediately after the passage of the blade becomes so conspicuous that stripes approximately parallel in the coating direction may occur in the same manner as described above. As a result, it is difficult to ensure a good coating film surface.

The invention was achieved under such circumstances. An object of the invention is to provide a blade coating apparatus and a disk coating apparatus which can apply a coating material stably in a simple apparatus configuration, to thereby prevent stripes from occurring in a coated surface.

The object of the invention is attained by the following configurations.

(1) A blade coating apparatus including: a mask having an opening portion, the mask being laid on top of a flat substrate to be coated; and a blade movable relatively to the mask and above the mask to apply a coating liquid onto the mask so that a coating liquid layer can be formed on the flat substrate in accordance with the opening portion of the mask when the mask is then removed; wherein a section of the blade perpendicular to a longitudinal direction of the blade is shaped as: a blade-movement-direction length of a pressure surface located on a lower side of the blade and facing a surface to be coated is 10 times to 20 times as large as a thickness of the coating liquid layer at the time of application; an angle α between the pressure surface and a front side surface of the blade located in front in the blade movement direction is in a range of 110°≦α<150°; and an angle β between the pressure surface and a rear side surface of the blade located at the rear in the blade movement direction is in a range of 60°≦β<100°.

In the blade coating apparatus, the blade-movement-direction length L of the pressure surface of the blade is set to be 10 times to 20 times as large as the thickness of the coating liquid layer, the angle α between the pressure surface and the front side surface is set to be in a range of 110°≦α≦150°, and the angle β between the pressure surface and the rear side surface is set to be in a range of 60≦β<100°. Accordingly, the blade can be formed into a sectional shape with high rigidity. The coating liquid layer applied by the blade can be made flat in terms of surface property. The thickness of the coating liquid layer can be made uniform.

When the angle α between the pressure surface and the front side surface is in a range of 110°≦α≦150°, the coating liquid is introduced into the gap (gap between the pressure surface and the to-be-coated surface) smoothly and the introduced coating liquid is pressed on the to-be-coated surface by the pressure surface with optimal pressure. When the angle β between the pressure surface and the rear side surface is in a range of 60°≦β<100°, there hardly occurs a so-called wicking phenomenon, i.e. a phenomenon that a part of the coated film is wicked up on the rear side surface of the blade immediately after the passage of the blade. Accordingly, it is possible to prevent the surface property of the coating liquid layer from being deteriorated due to the liquid wicked up on the rear side surface of the blade and then dropping down to the coated film.

(2) A blade coating apparatus according to the paragraph (1), wherein the thickness of the coating liquid layer at the time of application is in a range of from 100 μm to 300 μm.

In this blade coating apparatus, the sectional shape of the blade is defined. Thus, coating can be performed with a good surface property in spite of the coating liquid layer 100 μm to 300 μm thick.

(3) A blade coating apparatus according to the paragraph (1) or (2), the opening portion has an opening with a continuous length of at least 50 mm in the longitudinal direction of the blade.

In this blade coating apparatus, the opening portion of the mask has an opening with a continuous length of at least 50 mm in the longitudinal direction of the blade. Accordingly, coating can be performed on a large area, for example, in the case where the coating liquid layer is formed on the whole surface of a disk at a time.

(4) A disk coating apparatus including a blade coating apparatus according to any one of the paragraphs (1) through (3), the blade coating apparatus being used to form at least one layer of a printing surface of a disk-like recording medium.

In this disk coating apparatus, a coating apparatus capable of coating in a large area is used to form at least one layer of a printing surface of a disk-like recording medium. Accordingly, it is possible to form a uniform and high-quality coating liquid layer. Thus, the printing layer (ink accepting layer) on which printing will be performed, for example, by an inkjet printer can be formed to be thick enough to provide necessary and sufficient ink acceptability.

In the blade coating apparatus and the disk coating apparatus using the blade coating apparatus according to the invention, the rigidity of the blade can be enhanced. Accordingly, the coating liquid can be applied stably with uniform pressure. As a result, stripes can be prevented from occurring in the coated surface.

### BRIEF DESCRIPTION OF THE DRAWINGS

FIG. 1 is a schematic view showing the configuration of a coating apparatus according to the invention.

FIG. 2 is a schematic perspective view showing the external appearance of the coating apparatus depicted in FIG. 1.

FIG. 3 is an enlarged view of a blade depicted in FIG. 1.

FIGS. 4A-4C are explanatory views showing the procedure of a coating method according to the invention.

FIGS. 5D-5G are explanatory views showing the procedure of the coating method according to the invention.

FIG. 6 is a plan view of a to-be-coated member which has been completely coated.

### DESCRIPTION OF REFERENCE NUMERALS AND SIGNS

25 mask plate (mask)
27 opening portion
49 coating liquid
51 blade
55 front side surface
57 to-be-coated surface
59 pressure surface
61 rear side surface
63 control portion
100 blade coating apparatus
D optical disk (flat substrate)
L blade-movement-direction length
α angle between pressure surface and front side surface
β angle between pressure surface and rear side surface

### DETAILED DESCRIPTION OF THE INVENTION

A preferred embodiment of a blade coating apparatus and a disk coating apparatus using the blade coating apparatus according to the invention will be described below in detail with reference to the drawings.

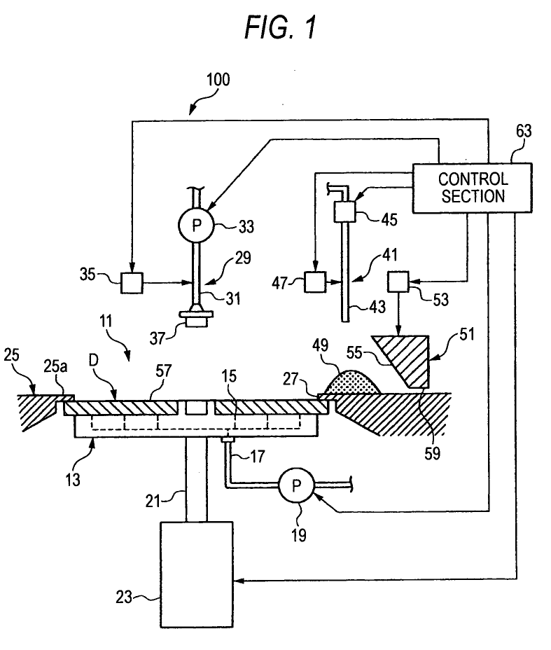

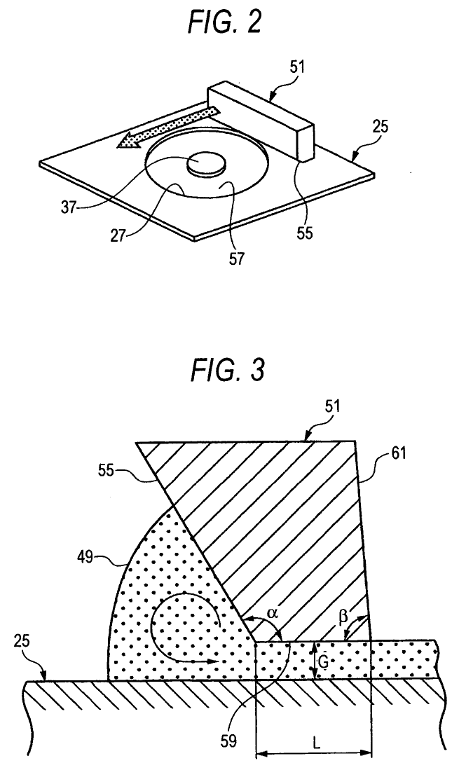

FIG. 1 is a schematic view showing the configuration of a coating apparatus according to the invention. FIG. 2 is a schematic perspective view showing the external appearance of the coating apparatus depicted in FIG. 1. FIG. 3 is an enlarged view of a blade depicted in FIG. 1.

The blade coating apparatus 100 according to the embodiment is used for applying a liquid film on a to-be-coated member represented by an optical disk D which is an example of a disk-like recording medium. A circular suction stage 13 is provided in a coating portion 11 of the blade coating apparatus 100 so that the optical disk D can be sucked and mounted on the suction stage 13. A plurality of suction holes 15 are opened in an upper surface of the suction stage 13. A vacuum pump 19 is connected to the suction holes 15 through a suction channel 17. When the vacuum pump 19 is operated, the suction stage 13 can suck and retain the optical disk D on the upper surface of the suction stage 13 through the suction holes 15.

The suction stage 13 is vertically movably supported by an elevating shaft 21 at the center of the lower surface thereof. The elevating shaft 21 is driven by an air cylinder 23 so as to move up/down.

A mask plate (mask) 25 is provided above the suction stage 13. The mask plate 25 has an opening portion 27 for exposing a to-be-coated surface of the optical disk D. When the elevating shaft 21 is driven by the air cylinder 23, the elevating shaft 21 moves up. As soon as the elevating shaft 21 reaches an upper limit position, an outer circumferential edge of the optical disk D mounted on the suction stage 13 is covered with an opening circumferential edge 25a of the mask plate 25.

The coating portion 11 is provided with a mask cap sucking/releasing unit 29 above a central portion of the optical disk D. The mask cap sucking/releasing unit 29 includes a cap suction nozzle 31, a vacuum pump 33 and an elevating unit 35. When the vacuum pump 33 is driven, the mask cap sucking/releasing unit 29 sucks and retains a mask cap 37 in a lower end of the cap suction nozzle 31. When the elevating unit 35 is driven in this condition, the cap suction nozzle 31 is moved down so that the mask cap 37 is inserted into a hole in the central portion of the optical disk D. The mask cap (center cap) is not limited to this configuration. The mask cap may be sucked/released by any other mechanical means. For example, there is a method in which the mask cap 37 thrust from below to thereby rise from the mask plate 25 is scooped out from side.

A coating liquid supply unit 41 is provided above the mask plate 25 and outside the opening portion 27. The coating liquid supply unit 41 includes a coating liquid supply nozzle 43, a coating liquid supply device 45 and a nozzle elevating device 47. By the coating liquid supply unit 41, a coating liquid 49 supplied from the coating liquid supply device 45 is dropped and supplied onto the mask plate 25 through the coating liquid supply nozzle 43. On this occasion, the coating liquid supply nozzle 43 is moved to a height close to the mask plate 25 by the nozzle elevating device 47 only when the coating liquid supply nozzle 43 needs to drop and supply the coating liquid 49. Ordinarily, the coating liquid supply nozzle 43 is moved up to a position where the coating liquid supply nozzle 43 will not be an obstacle to a coating process. Thus, the coating liquid supply nozzle 43 is made to stand by.

A blade 51 is disposed to stand by further outside the coating liquid 49 supplied onto the mask plate 25 by the coating liquid supply unit 41. When the blade 51 is driven by a moving unit 53 so as to move horizontally above the mask plate 25 while keeping a predetermined gap with the mask plate 25, the blade 51 moves while pushing the coating liquid 49 with its front side surface 55. Thus, the coating liquid 49 is applied onto a to-be-coated surface 57 of the optical disk D exposed by the opening portion 27 of the mask plate 25 as shown in FIG. 2.

The blade 51 is made of a metal material such as a stainless steel material formed to be long in a direction perpendicular to the paper surface of FIG. 1. As shown in FIG. 3, the blade 51 is formed into a substantially trapezoidal shape in section perpendicular to the longitudinal direction of the blade 51. In addition, as shown in FIG. 3, a gap G is formed between a lower surface of the blade 51 and the mask plate 25. The flow of the coating liquid 49 is guided by the front side surface 55 of the blade 51, with the result that the coating liquid 49 is pressed thereby. Thus, the coating liquid 49 is pushed into the gap G. When the coating liquid 49 passes the lower surface (pressure surface 59) of the blade 51 facing the to-be-coated surface 57 over a distance L, the coating liquid 49 is charged into the opening of the mask plate 25. As a result, the coating liquid 49 is applied evenly onto the to-be-coated surface 57.

Operations of the vacuum pump 19, the air cylinder 23, the vacuum pump 33, the elevating unit 35, the coating liquid supply device 45, the nozzle elevating device 47, and the moving unit 53 are controlled individually by a control portion 63.

When the opening portion 27 of the mask plate 25 has an opening extending with a continuous length of at least 50 mm in the longitudinal direction of the blade 51, an effect of uniform coating performance by blade coating according to the invention as will be described later becomes conspicuous. In the embodiment, the opening portion 27 is formed into a circular shape with a diameter of about 120 mm.

Here, a coating liquid with a viscosity of 150 cP to 800 cP can be preferably used as the coating liquid 49. It is especially desired that the viscosity is in a range of from 200 cP to 600 cP.

Here, the blade 51 of the blade coating apparatus 100 according to the invention satisfies all the following three conditions.

<Condition A>

The blade-movement-direction length L of the pressure surface 59 is set to be 10 times to 50 times or preferably 10 times to 20 times as large as the thickness of a coating liquid layer at the time of application. When the length L is set in the aforementioned range, the rigidity of the blade 51 is enhanced. Accordingly, even when the quantity of the coating liquid 49 pushed into the gap G between the blade 51 and the to-be-coated surface 57 increases, the coating liquid 49 can be pressed on the to-be-coated surface 57 by the pressure surface 59 having a large area, so that stable application of the coating liquid 49 can be attained.

<Condition B>

An angle α between the pressure surface 59 and the front side surface 55 is set to be in a range of 110°≦α<150°. With such setting, the coating liquid 49 is introduced into the gap G smoothly, and the introduced coating liquid 49 is pressed onto the to-be-coated surface 57 by the pressure surface 59 with an optimal pressing force.

<Condition C>

An angle β between the pressure surface 59 and a rear side surface 61 is set to be in a range of 60°≦β<100°. With such setting, there hardly occurs a so-called wicking phenomenon, that is, a phenomenon that a part of the coated film is wicked up on the rear side surface 61 of the blade immediately after the passage of the blade 51. Thus, due to the blade 51 having no distortion, coating pressure becomes so uniform that stable application of the coating liquid 49 can be attained.

In the blade coating apparatus 100 according to the embodiment, the thickness of the coating liquid layer at the time of application is at least 100 μm. When coating is performed thus with a coating thickness of at least 100 μm, the tendency for the surface property of the coating liquid layer to follow the surface of the to-be-coated surface 57 becomes lower than that in the case of thin coating. As a result, the shape of the blade 51 has great influence on the surface property of the coating liquid layer. That is, the surface property of the coating liquid layer is hardly influenced by the roughness of the to-be-coated surface 57, but chiefly depends on the pressure of the coating liquid applied by the blade 51, the wicking of the coating liquid due to the shape of the blade 51, etc. Due to a leveling phenomenon that possible stripes appearing immediately after application disappear over time, high frequency components of the stripes can be cancelled to some extent. However, due to thick coating, waves of low frequency components of the stripes are left. Therefore, the blade 51 is formed into a shape satisfying the aforementioned conditions. Thus, a coating liquid layer excellent in surface property without stripes or waves can be formed stably.

When the blade coating apparatus 100 is used as a disk coating apparatus for forming at least one of recording layers in a disk-like recording medium, a printing layer (ink accepting layer) on which, for example, an inkjet printer will print, can be formed. According to the disk coating apparatus, the printing layer can be formed with a necessary and sufficient thickness so that excellent color reproducibility can be secured when printing is performed on the printing layer. Practically when the coating liquid layer has a thickness of about 150 μm at the time of application, the coated film formed thus is about 30 μm thick due to loss in weight after drying. This ink accepting layer about 30 μm thick leads to excellent color reproducibility.

Next, a method for coating the coating liquid by use of the blade coating apparatus 100 will be described.

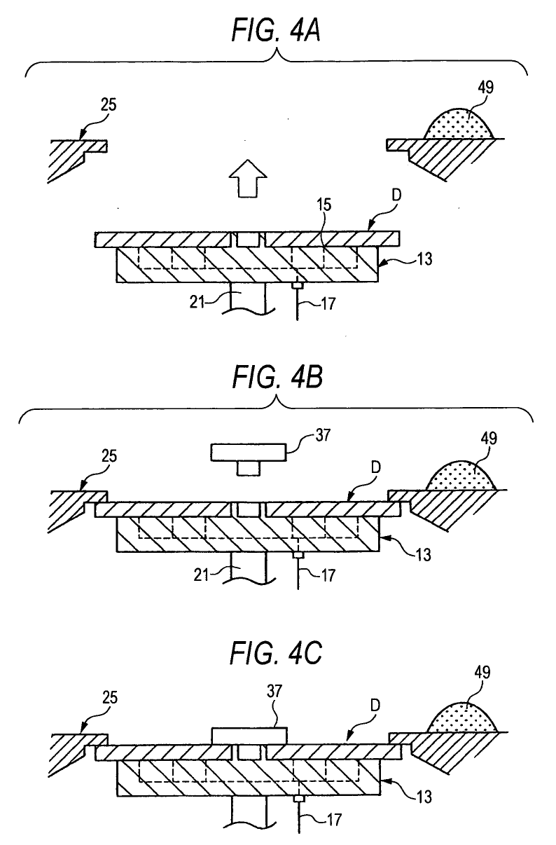

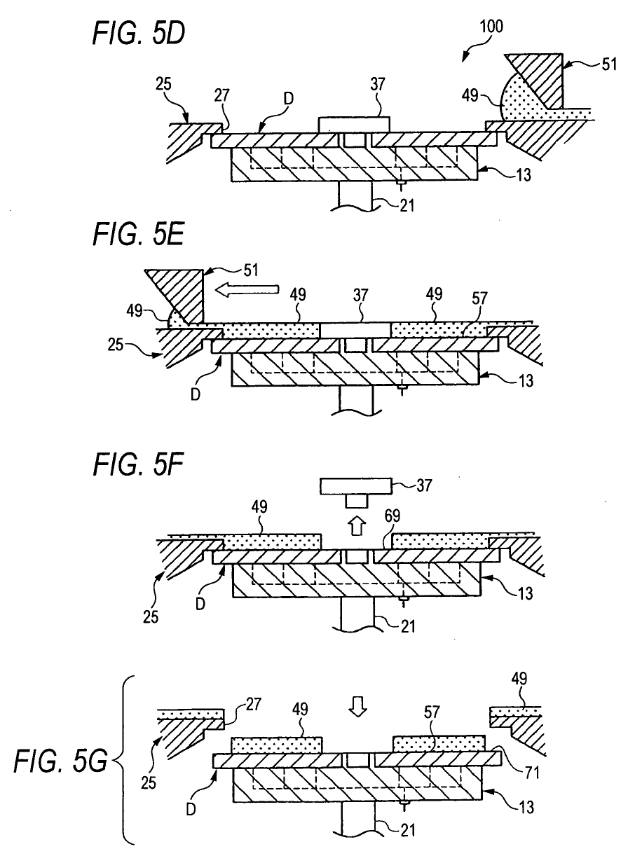

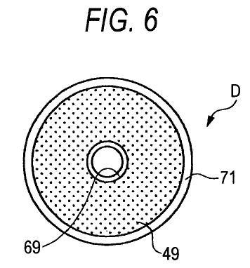

FIGS. 4A-4C are explanatory views showing the procedure of the coating method according to the invention. FIGS. 5D-5G are explanatory views showing the procedure of the coating method according to the invention. FIG. 6 is a plan view of a to-be-coated member which has been completely coated.

In the blade coating method, a supplied coating liquid 49 is applied to a to-be-coated surface 57 of an optical disk D exposed from an opening portion 27 of a mask plate 25, by use of a blade 51. The blade 51 has a pressure surface 59 with a predetermined blade-movement-direction length in section perpendicular to the longitudinal direction of the blade 51. The angle between the pressure surface 59 and a front side surface 55 is obtuse, and the angle between the pressure surface 59 and a rear side surface 61 is not smaller than 60°, and smaller than 100°.

First, as shown in FIG. 4A, in accordance with an instruction of a control portion 63, the optical disk D is sucked on a suction stage 13 in a position where an elevating shaft 21 is moved down. As shown in FIG. 4B, an air cylinder 23 is driven to move up the suction stage 13 so that the optical disk D abuts against the opening portion 27 of the mask plate 25. Then, as shown in FIG. 4C, a mask cap sucking/releasing unit 29 is driven so that a mask cap 37 is inserted into a central hole of the optical disk D.

As shown in FIG. 5D, the blade 51 is moved leftward by a moving unit 53 so as to move a coating liquid 49 dropped on the mask plate 25 by a coating liquid supply unit 41. Then, as shown in FIG. 5E, the blade 51 together with the coating liquid 49 passes the to-be-coated surface 57 of the optical disk D so that a coating liquid layer with a predetermined thickness is formed on the to-be-coated surface 57 of the optical disk D.

Then, as shown in FIG. 5F, the mask cap sucking/releasing unit 29 is driven so that the mask cap 37 is removed from the optical disk D. In this manner, a circular step portion 69 which is not coated with the coating liquid 49 is formed in the central portion of the optical disk D. Then, as shown in FIG. 5G, the air cylinder 23 is driven to move down the suction stage 13, so that the optical disk D is moved down to leave the opening portion 27 of the mask plate 25. Accordingly, the coating liquid 49 applied onto the to-be-coated surface 57 is separated from the coating liquid 49 on the mask plate 25 by shearing. As a result, an uncoated portion 71 which is not coated with the coating liquid 49 as shown in FIG. 6 is formed due to the outer circumferential edge of the optical disk D having been covered with the mask plate 25 till then.

Though not shown, the optical disk D coated with the coated liquid 49 as described above is removed from the suction stage 13 and transferred to a next process in which the coating liquid 49 will be dried.

In the aforementioned blade coating apparatus, the sectional shape of the blade 51 satisfies all the aforementioned three conditions A, B and C. Accordingly, the rigidity of the blade 51 is enhanced so that the coating liquid 49 can be applied with uniform coating pressure. As a result, stable application of the coating liquid 49 can be attained so that stripes can be prevented from occurring in the to-be-coated surface 57.

Incidentally, the shape of the coating portion can be set desirably by suitably changing the shape of the opening of the mask plate 25.

Although the blade 51 is made of a stainless steel material in the aforementioned blade coating apparatus 100, the invention is not limited thereto. For example, the blade 51 may be made of a resin material or hard rubber. In addition, although the blade coating apparatus is used for coating a printing surface of an optical disk in the embodiment, a piece to be coated is not limited thereto. Any piece to be coated can be coated if it has a thick film.

### EXAMPLES

### Example 1

Next, Examples and Comparative Examples in each of which a coating liquid 49 was applied onto an optical disk by a blade coating apparatus having the same configuration as that in the embodiment will be described.

A coating liquid composed of materials shown in Table 1 for forming an accepting layer in the optical disk was used. This coating liquid was applied with a thickness of 100-200 μm on a surface of the optical disk. Incidentally, the viscosity of the coating liquid was measured by a B-type viscosimeter (Vismetron) under an environment of 25°. As a result, the viscosity of the coating liquid was 500 cP.

TABLE 1

| Material | Quantity | |
|---|---|---|
| Vapor deposited silica particle | 8.0 | parts |
| Ion exchanged water | 52.5 | parts |
| Polyoxymethylene lauryl ether | 3.0 | parts |
| Aqueous solution of polyvinyl alcohol (9%) | 26.0 | parts |
| diethylene glycol monobutyl ether | 0.5 | parts |
| boric acid (6%) | 10.0 | parts |
| Total | 100.0 | parts |

Each coating apparatus for applying the coating liquid was designed so that the blade-movement-direction length L of the pressure surface was set at 2 mm which was 20 times as large of the thickness (i.e. 100 μm) of the coating liquid layer. The angle α between the pressure surface and the front side surface was in a range of from 90° to 150°, and the angle β between the pressure surface and the rear side surface was in a range of from 60° to 120°. Evaluation was made on the coating apparatus. Results of the evaluation are shown in Tables 2 and 3.

TABLE 2

| | Coating | Upstream | | |
|---|---|---|---|---|
| | thickness | end | | |
| | (liquid | portion | | |
| | film) | angle α | Stripes | Description |
| Example 1 | 100 μm | 110° | ◯ | Good coating |
| Comparative | 100 μm | 100° | X | Occurrence |
| Example 1 | | | | of two |
| | | | | stripes on |
| | | | | average |
| Example 2 | 150 μm | 120° | ◯ | Good coating |
| Example 3 | 150 μm | 110° | ◯ | Good coating |
| Comparative | 150 μm | 100° | XX | Occurrence |
| Example 2 | | | | of stripes |
| | | | | all over the |
| | | | | surface |
| Example 4 | 200 μm | 150° | ◯ | Good coating |
| Example 5 | 200 μm | 130° | ◯ | Good coating |
| Example 6 | 200 μm | 110° | ◯ | Good coating |
| Comparative | 200 μm | 90° | XX | Occurrence |
| Example 3 | | | | of stripes |
| | | | | all over the |
| | | | | surface |

TABLE 3

| | Coating | Downstream | | |
|---|---|---|---|---|
| | thickness | end | | |
| | (liquid | portion | | |
| | film) | angle β | Stripes | Description |
| Comparative | 100 μm | 100° | Δ | Slight |
| Example 4 | | | | stripes |
| Comparative | 100 μm | 110° | X | Occurrence |
| Example 5 | | | | of two |
| | | | | stripes on |
| | | | | average |
| Comparative | 150 μm | 90° | ◯ | Acceptable |
| Example 6 | | | | coating |
| Comparative | 150 μm | 100° | Δ | Slight |
| Example 7 | | | | stripes |
| Comparative | 150 μm | 110° | XX | Occurrence |
| Example 8 | | | | of stripes |
| | | | | all over the |
| | | | | surface |
| Example 7 | 200 μm | 60° | ◯ | Good coating |
| Example 8 | 200 μm | 80° | ◯ | Good coating |
| Comparative | 200 μm | 90° | ◯ | Acceptable |
| Example 9 | | | | coating |
| Comparative | 200 μm | 120° | XX | Occurrence |
| Example 10 | | | | of stripes |
| | | | | all over the |
| | | | | surface |
| Example 9 | 300 μm | 80° | ◯ | Good coating |
| Example 10 | 300 μm | 90° | ◯ | Acceptable |
| | | | | coating |
| Comparative | 300 μm | 120° | X | Occurrence |
| Example 11 | | | | of three |
| | | | | stripes on |
| | | | | average |

It could be known from Table 2 that Examples 1 to 6 showed good coating when the angle α between the pressure surface and the front side surface was in the range of 110°≦α≦150°, whereas Comparative Examples 1 to 3 showed occurrence of stripes when the angle α was in the range of α≦100°. It could be known from Table 3 that Examples 7 to 10 showed good coating when the angle β between the pressure surface and the rear side surface was in the range of 60°≦β<100°, whereas Comparative Examples 4 to 11 showed occurrence of stripes when the angle β was in the range of 100°≦β. Incidentally, when the angle β was equal to 100°, only slight stripes occurred.

When the blade-movement-direction length L of the pressure surface of the blade was smaller than 10 times as large as the film thickness to be coated, it was not possible to obtain an effect of making the pressure uniform. When the length L was over 20 times as large as the film thickness, the effect could not be enhanced correspondingly, but there arose a disadvantage that the scale of the blade increased.

This application is based on Japanese Patent application JP 2005-10569, filed Jan. 18, 2005, the entire content of which is hereby incorporated by reference, the same as if set forth at length.

What is claimed is:

1. A blade coating apparatus comprising:
a mask having an opening portion, the mask being laid on top of a flat substrate to be coated; and
a blade movable relatively to the mask and above the mask to apply a coating liquid onto the mask so that a coating liquid layer is formed on the flat substrate in accordance with the opening portion of the mask when the mask is removed;
wherein a section of the blade perpendicular to a longitudinal direction of the blade is shaped as:
a blade-movement-direction length of a pressure surface located on a lower side of the blade and facing a surface to be coated is 10 times to 20 times as large as a thickness of the coating liquid layer at the time of application;
an angle α between the pressure surface and a front side surface of the blade located in front in the blade movement direction is in a range of 110°≦α≦150°; and
an angle β between the pressure surface and a rear side surface of the blade located at the rear in the blade movement direction is in a range of 60°≦β<100°.

2. The blade coating apparatus according to claim 1, wherein a thickness of the coating liquid layer at the time of application is in a range of from 100 μm to 300 μm.

3. The blade coating apparatus according to claim 1, wherein the opening portion has an opening with a continuous length of at least 50 mm in the longitudinal direction of the blade.

4. A disk coating apparatus comprising:
a blade coating apparatus according to claim 1, the blade coating apparatus being used to form at least one layer of a printing surface of a recording medium.
